(19) United States
(12) Patent Application Publication
(10) Pub. No.: US 2016/0274227 A1
(43) Pub. Date: Sep. 22, 2016

(54) Systems, Devices, and/or Methods for Managing Transducers

(71) Applicant: Dustin Keith Wilhelm, Buena Vista, VA (US)

(72) Inventor: Dustin Keith Wilhelm, Buena Vista, VA (US)

(21) Appl. No.: 15/072,574

(22) Filed: Mar. 17, 2016

Related U.S. Application Data
(60) Provisional application No. 62/134,418, filed on Mar. 17, 2015.

(51) Int. Cl. G01S 7/521; G01S 15/02

(52) U.S. Cl. CPC G01S 7/521; G01S 15/02

(57) ABSTRACT

Certain exemplary embodiments comprise a system constructed to mount a transducer, such as a transducer constructed to determine water depth and/or the location of fish, to a shaft of a motor that propels a boat or watercraft. Mounting the transducer using an exemplary system can allow the transducer to operate without significant movement relative to a boat motor impellor axis as the boat motor impellor is rotated to turn the boat or watercraft.

### CROSS-REFERENCES TO RELATED APPLICATIONS

This application claims priority to, and incorporates by reference herein in its entirety, pending U.S. Provisional Patent Application Ser. No. 62/134,418 (Attorney Docket No. 1083-01), filed 17 Mar. 2015.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a profile view of an exemplary embodiment of a system 1000;

FIG. 2 is a close-up profile view of a portion of exemplary embodiment of system 1000 that comprises a transducer mount;

FIG. 3 is a close-up profile view of a portion of exemplary embodiment of system 1000 that comprises a transducer mount;

FIG. 4 is a close-up profile view of a portion of exemplary embodiment of system 1000 that comprises a system mount;

FIG. 5 is a close-up profile view of a portion of exemplary embodiment of system 1000 that comprises a transducer mount;

FIG. 6 is a close-up profile view of a portion of exemplary embodiment of system 1000 that comprises a terminal end;

FIG. 7 is a close-up profile view of a portion of exemplary embodiment of system 1000 that comprises a terminal end;

FIG. 8 is a flowchart of an exemplary embodiment of a method 8000′

FIG. 9 is a perspective view of an exemplary embodiment of a system 9000;

FIG. 10 is a perspective view of an exemplary embodiment of system 10000;

FIG. 11 is a perspective view of an exemplary embodiment of system 10000;

FIG. 12 is a perspective view of an exemplary embodiment of system 10000; and

FIG. 13 is a perspective view of an exemplary embodiment of a system 10000.

### DETAILED DESCRIPTION

Certain exemplary embodiments comprise a system constructed to mount a transducer, such as a transducer constructed to determine water depth and/or the location of fish, to a shaft of a motor that propels a boat or watercraft. Mounting the transducer using an exemplary system can allow the transducer to operate without significant movement relative to a boat motor impellor axis as the boat motor impellor is rotated to turn the boat or watercraft.

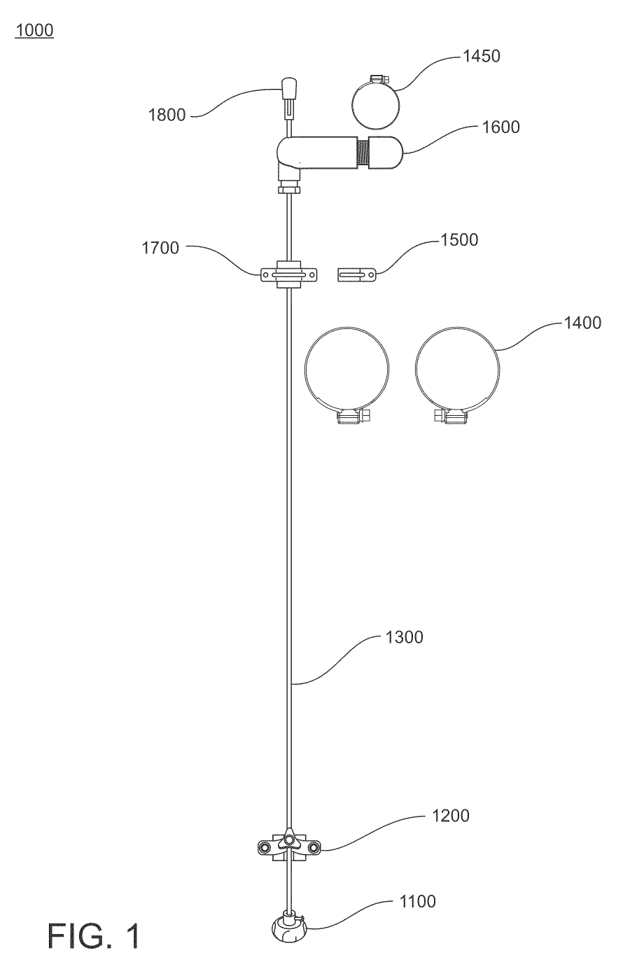

FIG. 1 is a side view of an exemplary embodiment of a system 1000, which can comprise a terminal end 1100, a first bracket 1200, a shaft 1300, a set of clamps 1400, a small system clamp 1450, a single eared bracket 1500, a transducer mount 1600, a second bracket 1700, and a transducer guard 1800.

Terminal end 1100 is constructed to allow a user to grip system 1000 when system 1000 is operatively installed on a motor shaft (not illustrated). Terminal end 1100 can have indentations to improve grippability. Terminal end 1100 is constructed to allow rotation of system 1000 relative to the motor shaft. When system 1000 is installed, rotating terminal end 1100 can allow a user to direct a transducer in a fixed direction relative to a direction of travel by a boat. By keeping a signal direction of transducer comprised by transducer mount 1600 in a consistent direction relative to the direction of travel of the boat, the user can improve fishing results by knowing the water depth and/or fish location in an area that has been recently and/or currently traversed by the boat.

First bracket 1200 is constructed to mount system 1000 to the fixed motor shaft. In the illustrated embodiment, fasteners are used to open a bracket comprised by first bracket 1200, place the bracket around the fixed motor shaft, and couple system 1000 to the motor shaft via the attachment of fasteners.

Shaft 1300 can be made from a somewhat elastically deformable material, such as, for example, fiberglass, polymer, plastic, aluminum, and/or polyvinyl chloride, etc. When operatively installed, shaft 1300 is constructed to retain a transducer (not illustrated) in a substantially fixed position relative to the motor shaft and/or an impellor of the motor.

Second bracket 1700 is constructed to mount system 1000 to the motor's lower unit. In some embodiments a two eared bracket is used (as illustrated with the bracket of second bracket 1700 on the shaft of the illustrated embodiment). In other embodiments, a single eared bracket 1500 can be used to operatively couple system 1000 to the motors lower unit via one or more of set of clamps 1400. If single eared bracket 1500 is used, the illustrated double eared bracket is replaced. For the two eared bracket, one of set of clamps 1400 is used to couple each ear of the two ear bracket to the motor shaft. For single eared bracket 1500, one of set of clamps 1400 is used to couple the ear of the single eared ear bracket to the motors lower unit.

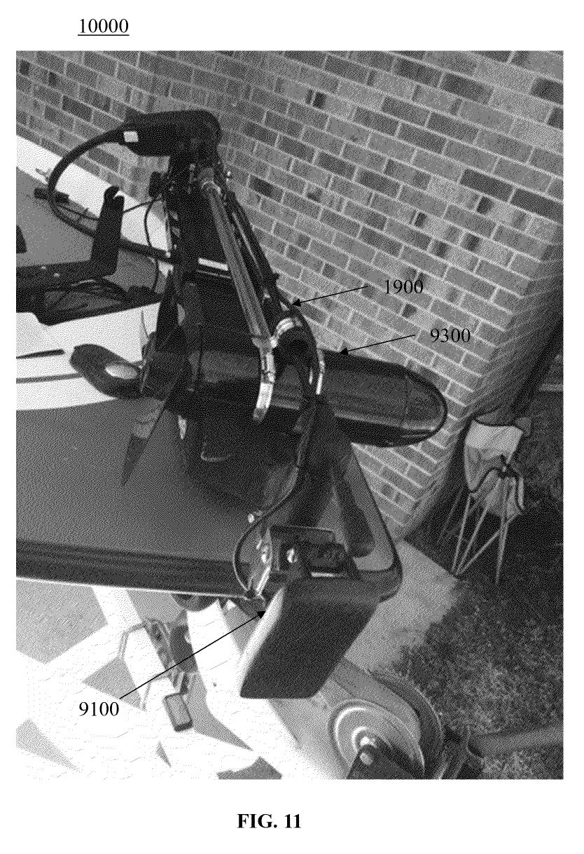

Transducer mount 1600 is constructed to be coupled to a transducer comprised by transducer mount 1600. The transducer is constructed to measure a water depth under the boat or watercraft, render a profile of an underwater surface, and/or locate fish detected by the transducer. The transducer can be coupled to system 1000 by small system clamp 1450. An electrical cable 1900 (see, electrical cable 1900 of FIG. 11) of the transducer can be supported by system 1000 and run along shaft 1300 to a user interface (not illustrated) in the boat or watercraft.

Transducer guard 1800 is constructed to be mounted upstream of the transducer relative to a direction of travel of the boat or watercraft. Weeds or other movable obstructions can contact transducer guard 1800 and deflected prior to contacting the transducer. Via transducer guard 1800, the integrity and life of the transducer can be improved and/or extended.

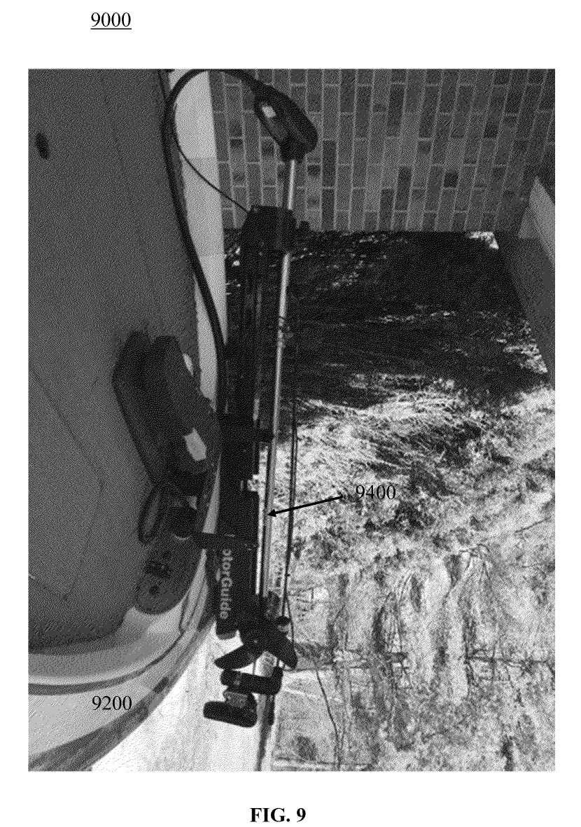

System 1000 can comprise:
transducer mount 1600 coupleable to the transducer (see, e.g., transducer 9100 of FIG. 11), wherein the transducer is constructed to determine at least one of water depth and a location of fish;
transducer guard 1800, which is coupled upstream of the transducer relative to a direction of travel of a boat (see, e.g., boat 9200 of FIG. 9) coupled to a motor (see, e.g., motor 9300 of FIG. 11); transducer guard 1800 is constructed to deflect objects to reduce a probability of damage to the transducer as the boat moves in water;
terminal end 1100, which is constructed to when coupled to a motor shaft (see, e.g., motor shaft 9400 of FIG. 9), allow rotation of the transducer by a user to change a direction of a signal of the transducer relative to a front of the boat; terminal end 1100 can comprise indentations that improve grippability;
system shaft 1300, which, when installed is constructed to retain the transducer in a substantially fixed position relative to the motor shaft; system shaft 1300 can be elastically deformable; system shaft 1300 can comprise fiberglass and/or plastic;
first bracket 1200, which is constructed to couple system shaft 1300 to the motor shaft via a first fastener; the first bracket can comprise parallel mounting shims 1260 that are placed around the motor shaft, the parallel mounting shims 1260 constructed to improve a coupling of system 1000 to the motor shaft;
small system clamp 1450, which is constructed to couple a transducer to transducer mount 1600;
second bracket 1700, which is coupleable to a lower portion of the motor via a second fastener; the second bracket can be a two eared bracket in some embodiments or a single eared bracket in other embodiments;
clamp 1400, which is constructed to couple an ear of second bracket 1700 to a portion of the motor's lower unit and thereby restrain motion of system shaft 1300 relative to the motor shaft; and/or
an electrical cable 1900 (see, electrical cable 1900 of FIG. 11) that runs along system shaft 1300 to provide electrical energy to the transducer and/or a signal from the transducer to a user interface.

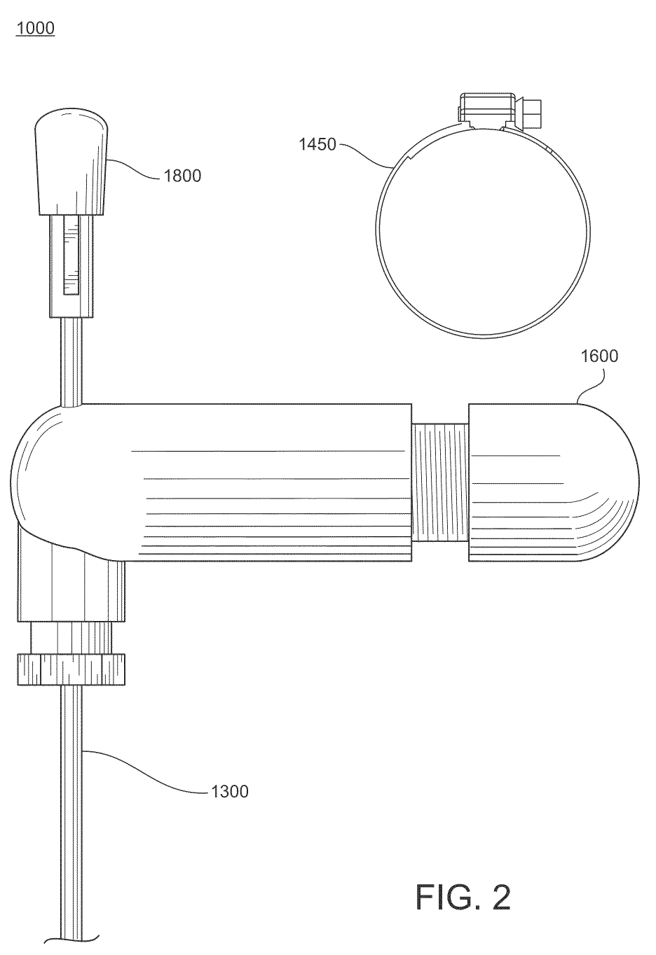

FIG. 2 is a photographic image of a close-up view of a portion of exemplary embodiment of system 1000 that comprises a transducer mount. FIG. 2 illustrates a close-up view of shaft 1300, small system clamp 1450, transducer mount 1600, and transducer guard 1800.

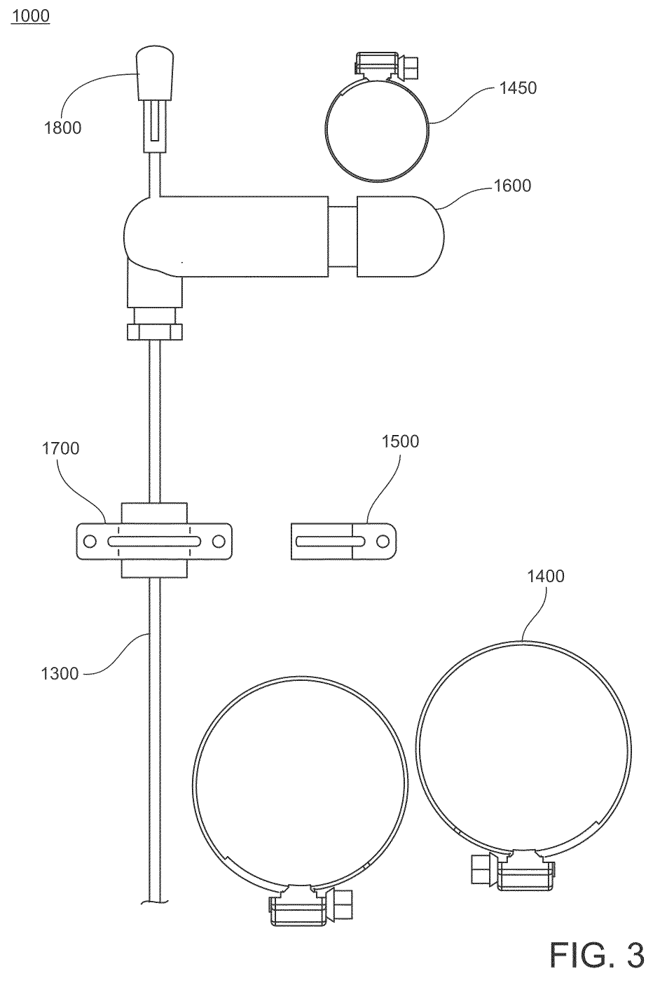

FIG. 3 is a photographic image of a close-up view of a portion of exemplary embodiment of system 1000 that comprises a transducer mount. FIG. 3 illustrates a close-up view of shaft 1300, set of clamps 1400, small system clamp 1450, single eared bracket 1500, transducer mount 1600, second bracket 1700, and transducer guard 1800.

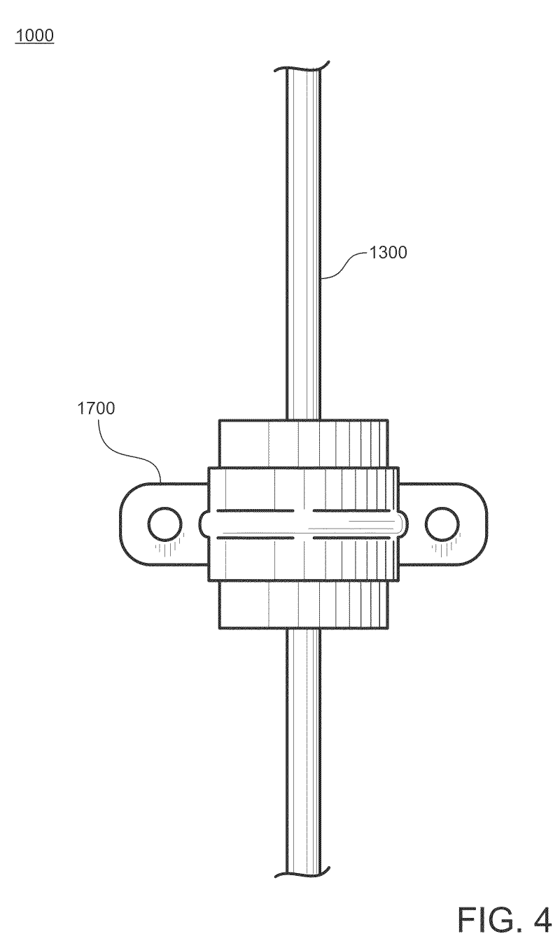

FIG. 4 is a photographic image of a close-up view of a portion of exemplary embodiment of system 1000 that comprises a bracket. FIG. 4 illustrates a close-up view of shaft 1300 and second bracket 1700.

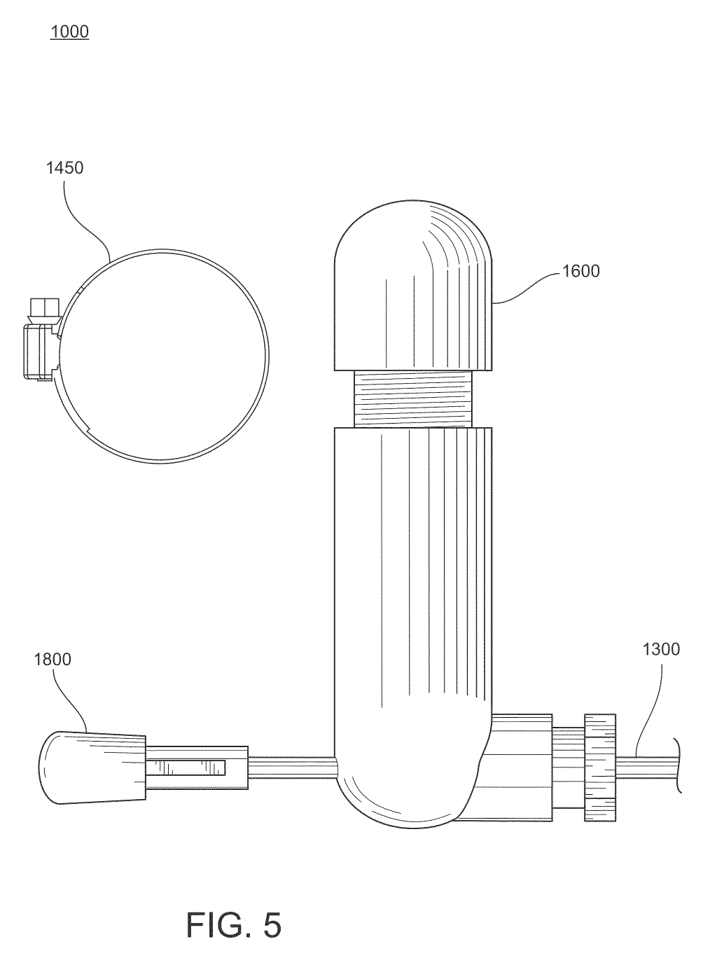

FIG. 5 is a photographic image of a close-up view of a portion of exemplary embodiment of system 1000 that comprises a transducer mount. FIG. 5 illustrates a close-up view of shaft 1300, small system clamp 1450, transducer mount 1600, and transducer guard 1800.

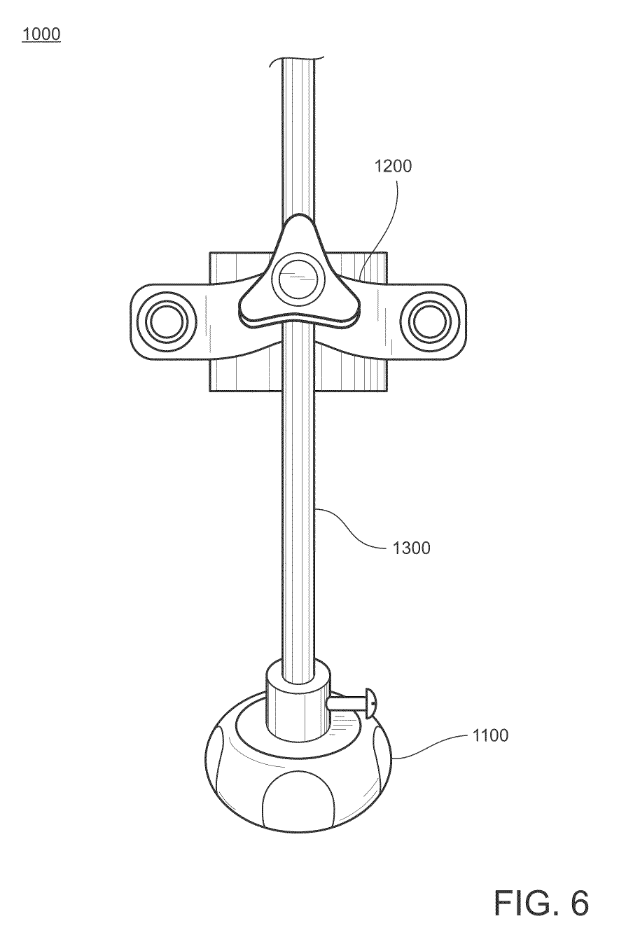

FIG. 6 is a photographic image of a close-up view of a portion of exemplary embodiment of system 1000 that comprises a terminal end. FIG. 6 illustrates a close-up view of terminal end 1100, first bracket 1200, and shaft 1300.

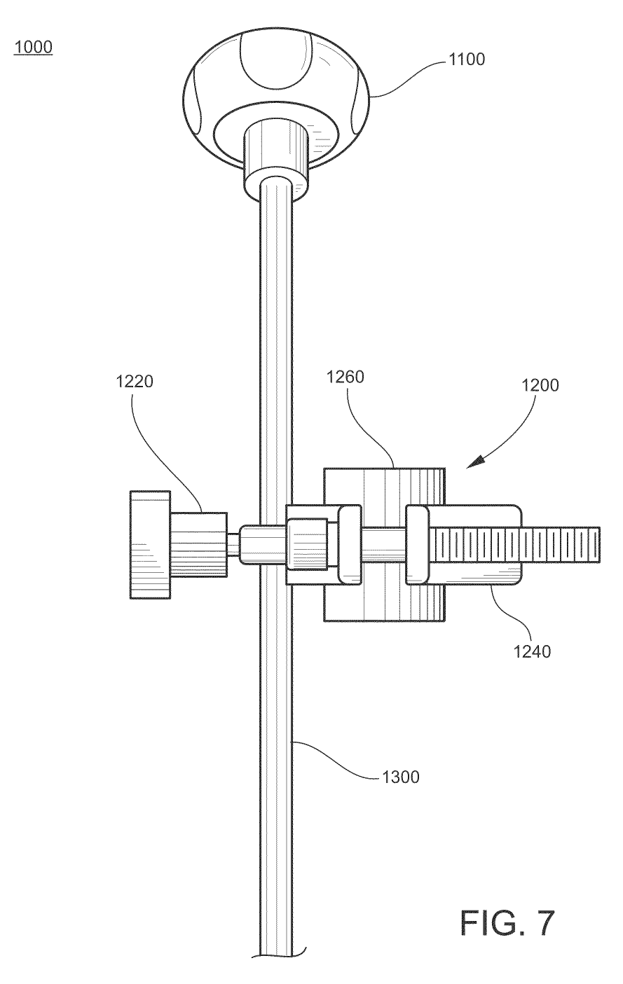

FIG. 7 is a photographic image of a close-up view of a portion of exemplary embodiment of system 1000 that comprises a terminal end. FIG. 7 illustrates a close-up view of terminal end 1100, first bracket 1200, and shaft 1300. The angle of the illustration of first bracket 1200 shows additional detail. First bracket 1200 comprises a shaft fastener 1220, which is used to releasably couple first bracket 1200 to shaft 1300. First bracket 1200 is constructed to mount system 1000 to the motors fixed shaft. In the illustrated embodiment, fasteners 1240 are used to release parallel mounting shims 1260 comprised by first bracket 1200, place parallel mounting shims 1260 around the motors fixed shaft, and couple system 1000 to the motors fixed shaft via the reattachment of fasteners 1240.

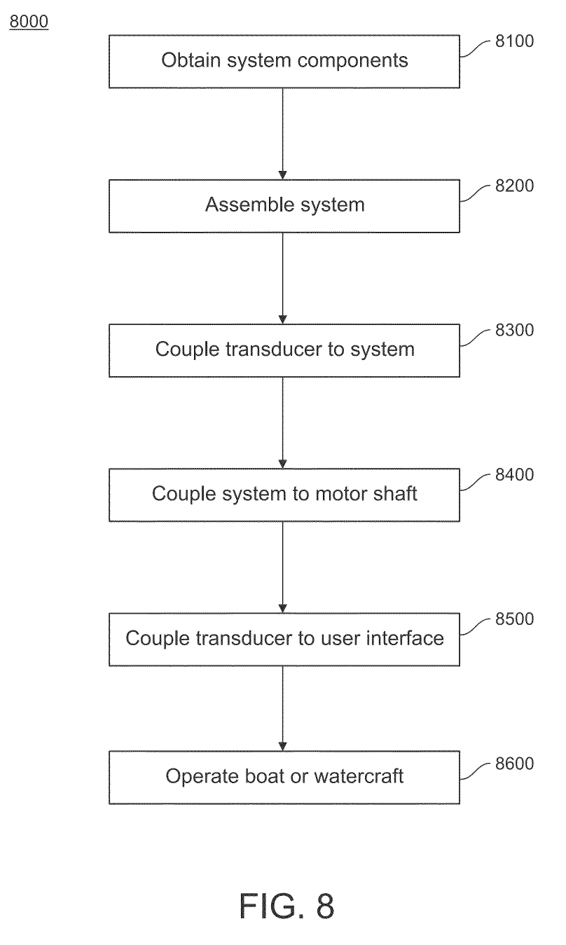

FIG. 8 is a flowchart of an exemplary embodiment of a method 8000. At activity 8100, system components can be obtained. The components can comprise a terminal end, a first system mount, a shaft, one or more clamps, a small system clamp, a bracket, a transducer mount, a second system mount, and a transducer guard. The first system mount can comprise a shaft fastener, which is used to releasably couple the first system mount to the shaft. The first system mount is constructed to mount the system to the motors fixed shaft. In certain exemplary embodiments, fasteners are used to release parallel mounting shims comprised by the first system mount, place the parallel mounting shims around the motors fixed shaft, and couple the system to the motors fixed shaft via the reattachment of the fasteners.

At activity 8200, the system can be assembled, for example, in the manner illustrated in FIG. 1. At activity 8300, a transducer, such as a depth finder transducer and/or a fish finder transducer, can be coupled to the system, such as system 1000 of FIG. 1. At activity 8400, the system can be coupled to a motor shaft of a motor that propels a boat or watercraft. At activity 8500, the transducer can be coupled or caused to be coupled to a motor shaft comprised by a boat or watercraft. The system can comprise:
A transducer mount, which can comprise the transducer, wherein the transducer is constructed to determine at least one of water depth and a location of fish;
a transducer guard, which is coupled upstream of the transducer relative to a direction of travel of a boat coupled to a motor; the transducer guard is constructed to deflect objects to reduce a probability of damage to the transducer as the boat moves in water;
a terminal end, which is constructed to when coupled to a motor shaft, allow rotation of the transducer by a user to change a direction of a signal of the transducer relative to the front of the boat; the terminal end can comprise indentations that improve grippability;
a system shaft, which, when installed is constructed to retain the transducer in a substantially fixed position relative to the motor shaft; the system shaft can be elastically deformable; the system shaft can comprise fiberglass and/or plastic;
a first bracket, which is constructed to couple the system shaft to the motor shaft via a first fastener; the first bracket can comprise parallel mounting shims that are placed around the motor shaft, the parallel mounting shims constructed to improve a coupling of the system to the motor shaft;
a small system clamp, which is constructed to couple the transducer to the transducer mount;
a second bracket, which is coupleable to a lower portion of the motor via a second fastener; the second bracket can be a two eared bracket in some embodiments or a single eared bracket in other embodiments;
a clamp, which is constructed to couple an ear of the second bracket to a portion of the motor's lower unit and thereby restrain motion of the system shaft relative to the motor shaft; and/or
an electrical cable that runs along the system shaft to provide electrical energy to the transducer.

At activity 8600, a user can operate the boat or watercraft and use information obtained via the transducer for boat navigation and/or to locate promising fishing areas.

FIG. 9 is a perspective view of an exemplary embodiment of a system 9000.

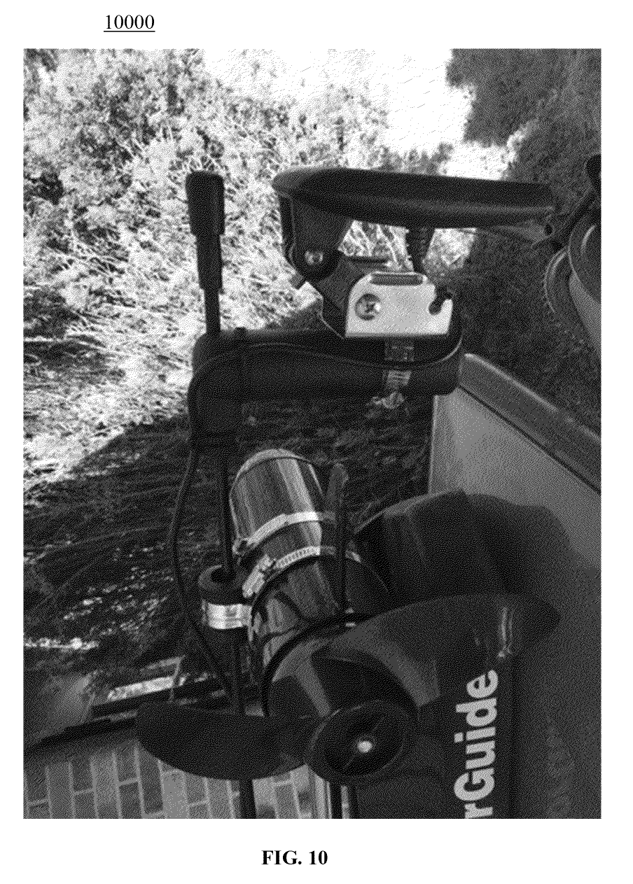

FIG. 10 is a perspective view of an exemplary embodiment of system 10000.

FIG. 11 is a perspective view of an exemplary embodiment of system 10000.

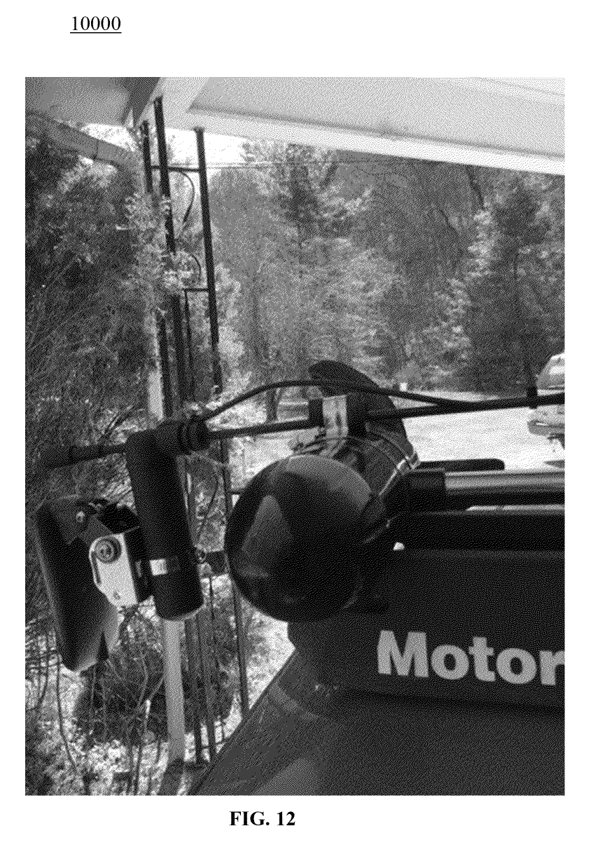

FIG. 12 is a perspective view of an exemplary embodiment of system 10000.

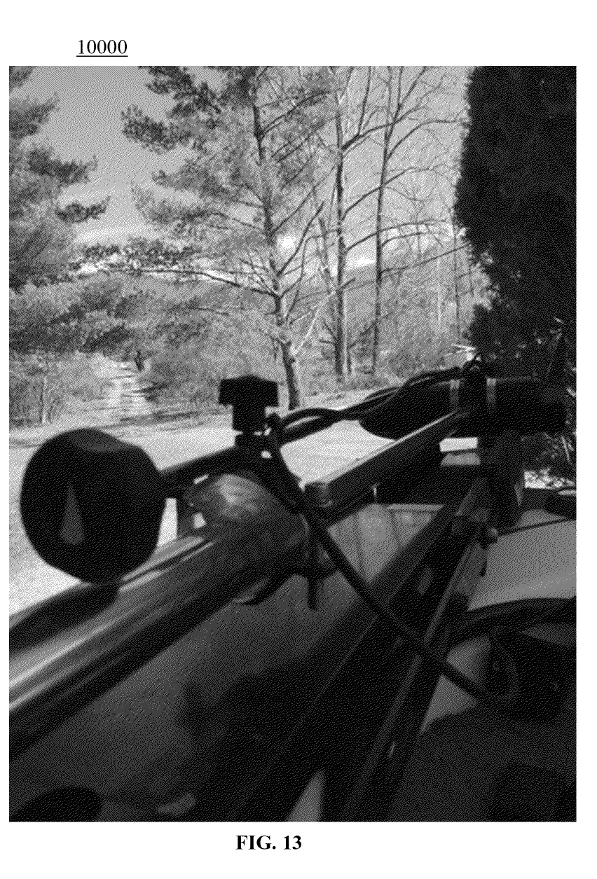

FIG. 13 is a perspective view of an exemplary embodiment of a system 10000.

### DEFINITIONS

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapter—a device used to effect operative compatibility between different parts of one or more pieces of an apparatus or system.
and/or—either in conjunction with or in alternative to.
apparatus—an appliance or device capable of performing a particular purpose.
associate—to join, connect together, and/or relate.
boat—a vessel constructed to travel on water.
bracket—a structural component that either supports a weight of, or restrains motion of, one or more system components.
can—is capable of, in at least some embodiments.
cause—to bring about an action or condition.
change—to make different.
clamp—a device that binds or presses two or more parts together so as to hold them firmly.
comprising—including but not limited to.
configure—to make suitable or fit for a specific use or situation.
connect—to join or fasten together.
constructed to—made to and/or designed to.
convert—to transform, adapt, and/or change.
couple—to join, connect, and/or link together.
coupleable—capable of being joined, connected, and/or linked together.
coupling—linking in some fashion.
damage—loss or harm resulting from an injury.
define—to establish the outline, form, or structure of.
deflect—to modify a position of something relative to an initial position.
determine—to ascertain after observation.
device—a machine, manufacture, and/or collection thereof.
direction—a line along which something (e.g., a boat or watercraft) moves.
ear—a flange of a component that is constructed to receive a fastener.
elastically deformable—capable of substantially returning to an original shape after having being subjected to a change of shape.
electrical cable—one or more insulated electrically conductive wires running side by side and bonded, twisted, or braided together to form a single assembly, the ends of which can be connected to two devices, enabling the transfer of electrical signals and/or energy from one device to the other.
electrical energy—an electric charge that is convertible to another form of energy to do work.
fastener—one (or more) restraint that attaches to, extends through, penetrates, and/or holds something. For example, a fastener can be one (or more) bolt and nut assembly, rivet, weldment, nail, screw, peg, staple, clip, buckle, clasp, clamp, hook and loop assembly, adhesive, and/or plastic push rivet, etc.
fiberglass—a material comprising filaments of glass that are combined in yarn and/or woven into fabrics, and embedded in various resins.
fish—an aquatic animal.
fixed—fastened in a substantially secure manner.
front—a foremost part of something when traveling in its primary direction of travel.
grippability—a capacity to be grasped by a user.
guard—a device and/or system that at least partially shields something from damage.
improve—to make better.
indentations—notches, incisions, and/or recesses.
install—to connect or set in position and prepare for use.
location—a place occupied by something.
may—is allowed and/or permitted to, in at least some embodiments.
method—a process, procedure, and/or collection of related activities for accomplishing something.
motor—a power unit constructed to impart motion to a boat and/or watercraft.
mount—(n) something on which something else is mounted; (v) to couple something to something else.
move—to travel from a first location to a second location.
object—a material thing.
parallel—extending in substantially a same direction.
plastic—any of a group of synthetic or natural organic materials that may be shaped when soft and then hardened, including many types of resins, resinoids, polymers, cellulose derivatives, casein materials, and proteins.
plurality—the state of being plural and/or more than one.
portion—a part of something.
predetermined—established in advance.
probability—a ratio of a number of outcomes in an exhaustive set of equally likely outcomes that produce a given event to the total number of possible outcomes.
provide—to furnish, supply, give, and/or make available.
receive—to get as a signal, take, acquire, and/or obtain.
reduce—diminish in magnitude.
relative—considered in connection to something else.
releasably—capable of being uncoupled without any substantial damage to the previously coupled things.
restrain—to limit movement relative to something else.
retain—to hold in a substantially secure manner.
rotation—a turning of something about an axis.
shaft—a substantially straight member that transmits motion and torque.
shim—a thin often tapered piece of material used to fill in space between things.
set—a related plurality.
signal—an electrical quantity or effect; as current, voltage, or electromagnetic waves; that can be varied in such a way as to convey information.
substantially—to a great extent or degree.
support—to bear the weight of, especially from below.
surround—to substantially encircle.
system—a collection of mechanisms, devices, machines, articles of manufacture, processes, data, and/or instructions, the collection designed to perform one or more specific functions.
terminal end—an extremity of a length of a system.
transducer—a device that receives a signal in the form of one type of energy and converts it to a signal in another form.
travel—to move from one place to another.
upstream—in front of, in a direction of travel.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
user—a human that employs something for a purpose.
via—by way of and/or utilizing.
watercraft—a boat or ship.
water depth—a distance from a surface of a river, ocean, lake, or pond and the earth's surface beneath the surface.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A system comprising:
a transducer mount couplable to a transducer, said transducer constructed to determine at least one of water depth and a location of fish;
a transducer guard, coupled upstream of the transducer relative to a direction of travel of a boat coupled to a motor, said transducer guard constructed to deflect objects to reduce a probability of damage to said transducer as said boat moves in water;
a terminal end, said terminal end constructed to when coupled to a motor shaft, allow rotation of said transducer by a user to change a direction of a signal of said transducer relative to a front of said boat;
a system shaft, when installed said system shaft is constructed to retain said transducer in a substantially fixed position relative to said motor shaft;
a first bracket that is constructed to couple said system shaft to said motor shaft via a first fastener;
a small system clamp, said small system clamp constructed to couple said a transducer to said transducer mount;
a second bracket, said second bracket coupleable to a lower portion of said motor via a second fastener; and
a clamp, said clamp constructed to couple an ear of said second bracket to a portion of said motor shaft and thereby restrain motion of said system shaft relative to said motor shaft.

2. The system of claim 1, further comprising:
a transducer comprising an electrical cable that runs along said system shaft to provide electrical energy to said transducer.

3. The system of claim 1, wherein:
said first bracket comprises parallel mounting shims that are placed around said motor shaft, said parallel mounting shims constructed to improve a coupling of said system to said motor shaft.

4. The system of claim 1, wherein:
said system shaft is elastically deformable.

5. The system of claim 1, wherein:
said system shaft comprises fiberglass.

6. The system of claim 1, wherein:
said system shaft comprises plastic.

7. The system of claim 1, wherein:
said terminal end comprises indentations that improve grippability.

8. The system of claim 1, wherein:
said second bracket is a two eared bracket.

9. The system of claim 1, wherein:
said second bracket is a single eared bracket.

10. A method comprising:
causing a system to be coupled to a motor shaft, said system comprising:
a transducer mount couplable to a transducer, said transducer constructed to determine at least one of water depth and a location of fish;
a transducer guard, coupled upstream of the transducer relative to a direction of travel of a boat coupled to a motor, said transducer guard constructed to deflect objects to reduce a probability of damage to said transducer as said boat moves in water;
a terminal end, said terminal end constructed to when coupled to said motor shaft, allow rotation of said transducer by a user to change a direction of a signal of said transducer relative to a front of said boat;
a system shaft, when installed said system shaft is constructed to retain said transducer in a substantially fixed position relative to said motor shaft;
a first bracket that is constructed to couple said system shaft to said fixed motor shaft via a first fastener;
a small system clamp, said small system clamp constructed to couple a transducer to said transducer mount;
a second bracket, said second bracket coupleable to a lower portion of said motor via a second fastener; and
a clamp, said clamp constructed to couple an ear of said second bracket to a portion of said motor shaft and thereby restrain motion of said system shaft relative to said motor shaft.

11. A system comprising:
a transducer guard, couplable upstream of a transducer relative to a direction of travel of a boat coupled to a motor, said transducer guard constructed to deflect objects to reduce a probability of damage to said transducer as said boat moves in water; and
a terminal end, said terminal end constructed to when coupled to a motor shaft, allow rotation of said transducer by a user to change a direction of a signal of said transducer relative to a front of said boat.
